(19) United States
(12) Patent Application Publication
(10) Pub. No.: US 2015/0219270 A1
(43) Pub. Date: Aug. 6, 2015

(54) CONVERTIBLE INSULATION HOLDER PIN

(71) Applicant: Duro Dyne Corporation, Bay Shore, NY (US)

(72) Inventor: Stephen S. Martin, Huntington Station, NY (US)

(73) Assignee: Duro Dyne Corporation, Bay Shore, NY (US)

(21) Appl. No.: 14/420,256

(22) PCT Filed: Aug. 8, 2013
(86) PCT No.: PCT/US2013/054137

§ 371 Date: Feb. 6, 2015

Related U.S. Application Data
(60) Provisional application No. 61/681,822, filed on Aug. 10, 2012.

(51) Int. Cl. F16L 59/12; B23K 11/00; F16B 19/00; F16B 15/00; F16B 43/00

(52) U.S. Cl. CPC F16L 59/123; F16B 15/00; F16B 43/00; F16B 19/00; B23K 11/0053

(57) ABSTRACT

A foldable pin and base washer combination capable of being connected to a duct surface by welding or by an adhesive. In the unfolded position, the combination meets the preferred industry standard for securing a sheet or batte of insulation to a wall of an HVAC duct, and in the folded position the combination can be more efficiently and compactly packaged and shipped. The pin is preferably made from an electrically conductive material, preferably a metal, but the base washer can be formed of a metal or a rigid polymer material.

### FIELD OF THE INVENTION

The present invention is directed to a further improvement in the retention of insulation batting for air ducts, e.g., as used in the HVAC field.

### BACKGROUND OF THE INVENTION

For many years the industry has used mechanical or weldable pins to hold insulation material, generally formed of fibrous batting, onto the usually metallic skin of an HVAC air duct, or other type of duct. Such products are shown, for example, in prior U.S. Pat. No. 5,325,964 to John E. Lyons and commonly assigned to Duro Dyne Corporation; U.S. Pat. No. 4,482,795 to Milton Hinden, also commonly assigned to Duro Dyne; U.S. Pat. No. 3,624,340 to Hinden, commonly assigned to Duro Dyne. As seen, these include a flat strip of stamped-out tines, folding flat pins designed to allow for closer packing and, therefore, a greatly reduced shipping cost when shipping across the ocean or intercontinentally by allowing for tighter packing over the products in a packing box or container. The tines were outwardly bendable so as to extend transversely outwardly from the flat strip. The reverse side of the strip could hve an adhesive applied, so it could adhere to the wall of a duct or the tip of the pin could be welded to the duce wall. The industry, however, apparently has preferred the use of the original straight pin, i.e., formed of a separate round pin having a tapered end, generally conically or pyramidally shaped at the end point, with a flat base washer to secure the pin to the batting at the outer end, while the inwardly extending point is welded to the metal or polymeric skin of an HVAC duct. However, the industry was unable to provide for the straight pin design the desired lower shipping costs of the folding design, which could only be secured to the duct by an adhesive connection.

### SUMMARY OF THE INVENTION

The present invention is directed to a further improvement of an insulation support pin having all of the desirable characteristics of both the weldable and adhesive-connected pin and washer combination preferred by the industry with the additional advantage of improved shipping characteristics to reduce the overall cost of supplying such devices around the world. In accordance with the present invention, the base washer is formed either as a polygonal flange shape or a circular or ovoidal flange shape; the pin, in the form, e.g., of a nail having a sharpened, generally conically or pyramidally shaped, tip. The pin, at its head end, passes through an opening preferably substantially centered on the base washer so as to be firmly secured to the base washer. The base washer is provided with a preferably centrally located three-sided cut-out surrounding the pin and forming a flap portion so that the flap and the pin can be resiliently folded into a more compact shape with the base washer, and, thus, reduce the excessive cost of shipping around the world. The pin is preferably formed of an electrically conductive, resilient metal, such as steel or aluminum. The base washer can be formed of the same or similar metal or can be formed of a polymer. The base washer need not be conductive as long as the head of the pin is directly accessible on the reverse side of the base washer. In addition, if desired, the support pin of the present invention is convertible, in the sense that it can be used either as a welding pin, where the tip of the pin is welded to the duct or, alternatively, the reverse side of the base washer holding the pin can be adhesively secured to the wall of the duct so that the pin extends outwardly from the duct wall, and through the insulation.

In order to maintain the structural integrity of the convertible support pin, whether it is used as a welded support or an adhesively connected support, the base washer should have a surface area of at least about 100 times, and preferably at least about 200 times, the cross-sectional area of the shank of said pin, and the flap portion should have a surface area of at least about 20 times, and preferably at least about 30 times, the cross-sectional area of the shank of said pin. The pin is preferably mechanically secured to the base washer, e.g., where the shank is tightly held within an opening through the base washer material and the head of the pin is exposed from the underside of the base washer when being used as a weldable connection. The head of the pin preferably has an outer surface area of at least about 5 times, and preferably at least about 10 times, the cross-sectional area of the shank of said pin

In accordance with one preferred embodiment of this invention, where the base washer is adhesively secured to the duct wall, an insulation batte, or insulating sheet, can be impaled onto the sharp point of the protruding pin and the outer end of the pin capped, utilizing a locking washer or a washer with a cap to cover the pointed tip. The locking washer is mountable over the end of the pin. The locking washer includes a slot which can grip the end of the pin and, thereby, secure it to the outer surface of the batting while the inner end of the pin is adhesively secured with its base washer to the outer surface of the duct. Preferably, notches are found along the pin shank to further secure the locking washer to the shank. At a certain distance from the end of the pin, there can be a slot to facilitate folding the shank of the pin over the top of the locking washer, if the cap is not desirable, in order to hold the locking washer to the top of the batting and, thus, to provide for a double use of the pin for both its total length and for the lower, shorter length up to the fold.

Alternatively, the pin can be used to first pierce the batting so that its base rests upon the top of the batting and the pointed end of the pin touches or pierces the skin of the HVAC duct; the pointed end can then be resistance-welded to the duct wall for an even more secure retention. This combination of effects is not readily provided by the prior folding systems of the prior art, which does not provide for weldability.

Further descriptions of the invention and its various embodiments are shown in the accompanying drawings and the further detailed description of the drawings.

### BRIEF DESCRIPTION OF THE DRAWINGS:

FIG. 1 is a side elevation view showing a preferred embodiment of the present invention in an upright position;

FIG. 2 is a top plan view showing the preferred embodiment of FIG. 1;

FIG. 3 is an isometric view showing the preferred embodiment of FIG. 1;

FIG. 4 is a top plan view showing the embodiment of FIG. 1 in its folded condition;

FIG. 5 is a side elevation view showing the embodiment of FIG. 1 in a folded condition;

FIG. 6 is an isometric view of the embodiment of FIG. 1 in a folded condition;

FIG. 7 is an isometric view showing a preferred embodiment of a pin washer;

FIG. 7A is a top plan view of the pin washer of FIG. 7; and

FIG. 7B is a side elevation view of the pin washer of FIG. 7.

FIG. 8 is a bottom plan view of the preferred embodiment of FIG. 4;

FIG. 9 is a cross-section side view of another embodiment, showing notches along the shank of the pin;

FIG. 10 is an isometric view showing a preferred embodiment of a pin cap;

FIG. 10A is a side elevation view of the pin cap of FIG. 10;

FIG. 10B is a bottom plan view of the pin cap of FIG. 10; and

FIG. 10C is a top plan view of the pin cap of FIG. 10.

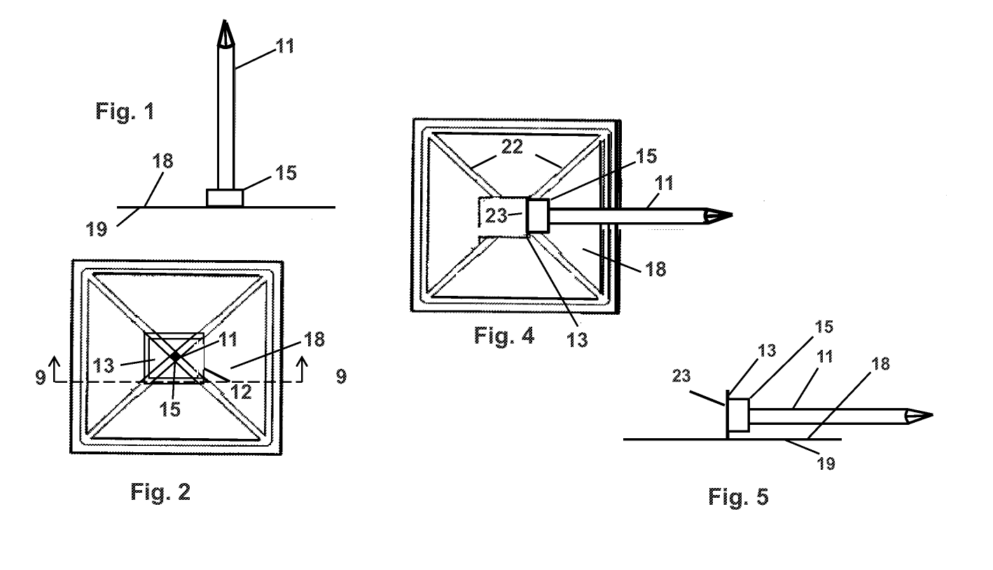

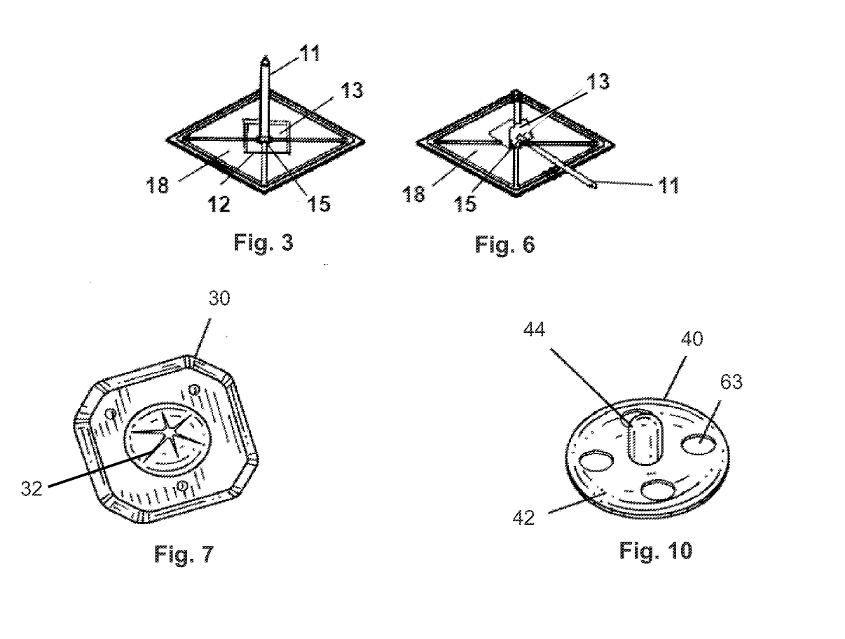

### DETAILED DESCRIPTION OF THE INVENTION

Referring to the drawings, the convertible insulation pin holder comprises a base washer portion 18, which can be formed of ribbed sheet metal or of a rigid polymer, either stamped or cast to shape. The shape as shown is a rectangular polygon; however any shape of sufficient surface area can be used as the support, or base washer, for the pin 11 of the present invention. Pin 11 is generally formed of carbon steel so as to have the necessary rigidity and electrical conductivity and is secured as by a pressure collar 15 to the cut-out folding portion 13 of the base washer 18. The head 29 of the pin 11 is held on the reverse side of the base and the shank of the pin 11 passes through the folding portion 13 of the base washer 18 and extends outwardly from the other side.

In accordance with the present invention, the undersurface 19 of the base washer can be either the exposed metal or, in another preferred embodiment, can be covered with an adhesive material which can be used to firmly secure the base to an air duct surface, for example. The base washer in this case can be formed of any rigid material, including a polymer plastic having the desired rigidity. Alternatively, the pin holder of the present invention can be secured by welding, such as resistance welding, between the point of the pin and a metallic surface, such as the metal wall surface of a duct. Both systems of connection are well known in the art, but the present system provides convertibility in that it can be formed as a weldable insulation fastener or an adhesively connected insulation fastener in a more efficiently shipped format. The product of the present invention has the ability to be folded during storage or shipment so as to substantially reduce the volume required for a given number of the convertible pin holders in a container or other package, and then straightened for use as the classic pin and base washer combination.

The foldable portion of the base 13 to which the pin 11 is secured is generally centrally located on the base washer, and is a resiliently foldable flap 13, which can be formed, for example, by cutting around three sides of a previously formed base washer, or can be cast or molded with the flap. The base is foldable at the intersection 12 of the cut out portion 13 and the main surfaces of the base washer 18, 19; however, in use, the base should be sufficiently rigid, especially when welded, to act as a washer to hold the insulation in place. To increase the rigidity of the overall base, ribs 22 can be formed as shown in the drawings.

The adhesive, such as used for the connection, can be of any type that will adhere to the material of the base washer 18 and to the material of the duct wall to which the insulation is to be connected. Alternatively, a two-sided tape can be used, one side can have an adhesive adherent to the base material and the other side of the tape an adhesive adherent to the duct wall. Preferably, a release sheet is on the second side, for use during shipment or storage.

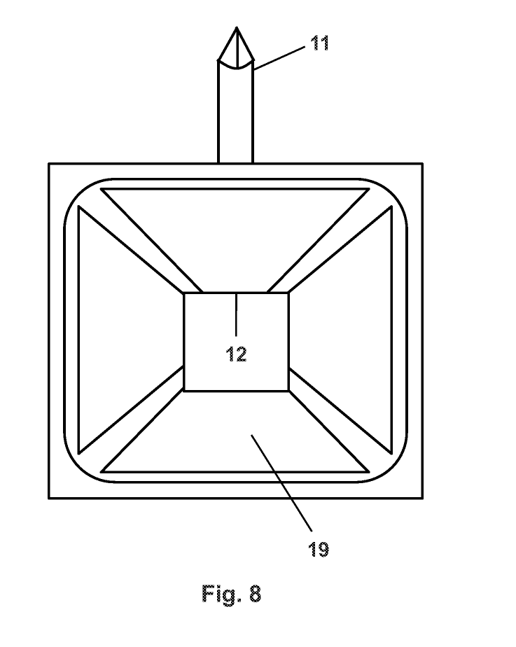

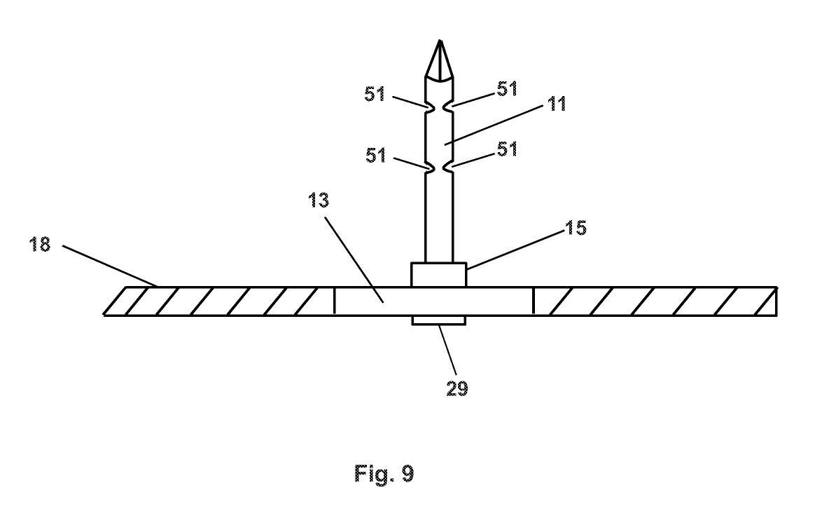

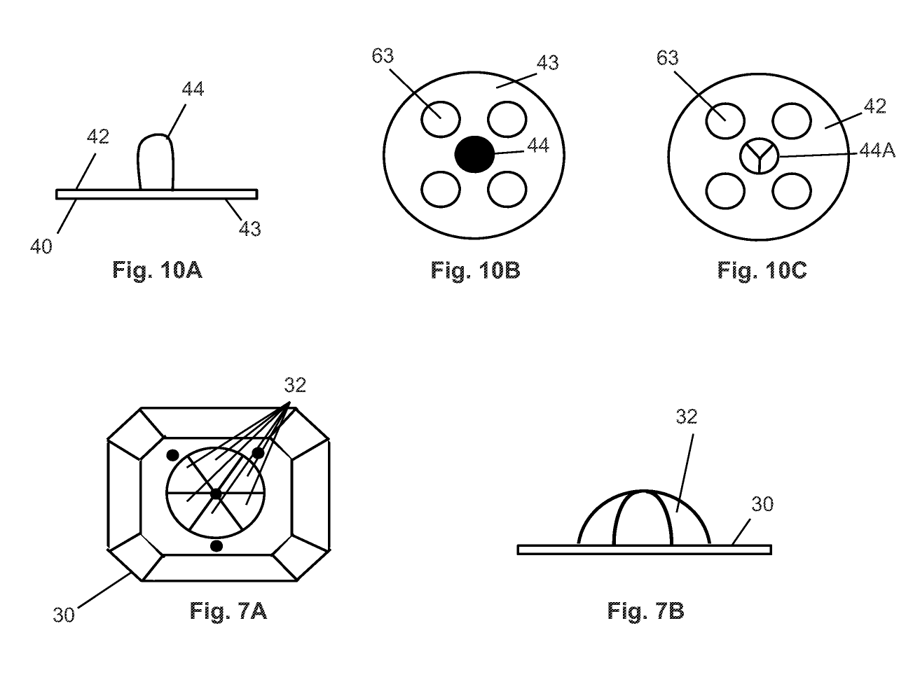

When used in the adhesive format, the base washer can be adhesively secured to the duct wall, and the pin 11 extends outwardly through the batting of the insulation and is capped by a washer or a cap 40, which will prevent the batting from being removed from the pin. One example of such a cap 40 is shown in FIGS. 10 through 10c. The peak 44 of the cap 40 can have gripping fingers 44a (in FIG. 10c) or can be filled with an adhesive (44, in FIG. 10b) to hold the point of the pin; alternatively, or in addition, the rim 42, 43 can be adhesively secured to the top surface of the insulation batte, and excess adhesive can leak out through the holes 63. The pin can also be capped by a washer 30, as shown for example in FIGS. 7 through 7b. The washer 30 has central resilient gripping fingers 32, to hold the pin. If desired, in one preferred embodiment, the point of the pin 11 can be bent over to fully secure the washer to the pin or it can be an enclosed cap 40 having gripping means to connect with the pin and thereby secure the cap 40 to the pin as by crimping.

The end portion of the pin, closest to the point 11, in another preferred embodiment, can have notches 51 formed thereon, which can mate with the spring-loaded fingers on the washer or cap 40, to more firmly secure the washer 30 to the pin 11. Such items are well known in the field and do not in themselves form a part of this invention. Similarly, the use of the two-sided tape is further well known and does not itself form a part of this invention. Alternatively, a layer of adhesive can be applied directly to the base 19 of the pin and a release layer applied to the top of that adhesive layer, when the bse washer and duct wall are formed of similar materials.

The pin base 13, 23 can be folded at the joint 12 as shown in FIGS. 4, 5, 6 and 8. This allows the system to be stored in much less space than would otherwise be required and would allow a much more efficient and less costly packaging when being shipped long distances as, for example, intercontinentally.

When used in the welding format, the insulation is applied to the surface of the duct and the pin is pushed through the insulation, whether it is a batting or a foam sheet, and resistance welding will secure the point of the pin to the metallic skin of the duct in a manner, for example, as is set forth in earlier U.S. Pat. No. 3,624,340.

In addition, if the corrugated shank has notches and/or corrugations along its length, that will further help to retain the insulation material on the duct.

While the invention has been described and illustrated in conjunction with the preferred embodiment shown in the drawings, it is understood that the specific configurations shown are not critical to the advantageous performance of the present invention. Rather, it is possible to use a variety of different shapes and materials to form the components of the present invention and to obtain the advantages described herein.

It will be apparent to those skilled in the art, after reviewing the above disclosure and drawings, that many variations will be available for the specific details without departing from the scope and spirit of the invention and, therefore, the invention is to be broadly construed within the scope of the following claims.

The following invention is claimed:

1. A convertible pin and base washer combination for supporting insulative batts or the like to a metal or solid polymer substrate comprising, in combination, a pin comprising an axially elongate shank portion having a head at one end and a sharp tip at the other end, a base washer having a centrally located foldable flap portion, formed in the base washer and being connected to the base washer along one edge, the base washer and foldable flap portion having a first surface and an opposed second surface; and the shank portion extending outwardly from the first surface of the foldable flap portion and the head being adjacent the second surface of the foldable flap portion, the head of the pin being centrally connected securely to the flap portion; the base washer having a cross-sectional area of at least about 100 times the cross-sectional area of the shank of said pin, and the flap portion having a cross-sectional area of at least about 20 times the cross-sectional area of the shank of said pin.

2. The convertible pin and base washer combination of claim 1, intended to be used as a welding pin, wherein the base washer and flap portion have front and reverse sides, the head of the pin is exposed on the reverse side of the foldable flap portion and the shank portion extending through the foldable flap portion and outwardly from the first surface of the flap portion.

3. The convertible pin and base washer combination of claim 1, wherein said tip is conical, the point defining an included angle of about 35 degree to about 55 degree, so as to be able to readily pierce a layer of insulation.

4. The convertible pin and base washer combination of claim 1, wherein the flap is resiliently foldable between a position axially parallel with the base washer first surface and a position substantially transverse thereto, so that the shank extends outwardly from the base.

5. The convertible pin and base washer combination of claim 1, intended to be adhesively connected to a substrate, wherein the base washer and flap portion have front and reverse sides, the head of the pin being exposed on the reverse side of the base washer and flap portion and the shank portion extending outwardly from the front surface of the flap portion and base washer; the combination further comprising an adhesive layer applied to said rear surfaces of the base washer and the flap portion, and an outer release layer remote from said reverse surfaces.

6. The convertible pin and base washer combination of claim 5, wherein the adhesive layer is applied by a double faced adhesive tape member coextensive with said reverse sides, said tape member including a first face adhesively bonded to the reverse surfaces and a second surface coated with an adhesive layer and covered by the outer release layer.

7. The convertible pin and base washer combination of claim 1, wherein the base washer and foldable flap and pin are formed of metal.

8. The convertible pin and base washer combination of claim 7, wherein the base washer and foldable flap are formed of a metal selected from the group consisting of steel, stainless steel and aluminum.

9. The convertible pin and base washer combination of claim 1, further comprising notches formed along the shank portion of the pin.

10. The convertible pin and base washer combination of claim 1, further comprising an adhesive coating the second surface of the base washer and folable flap, whereby the convertible pin and base washer can be secured to a surface to be insulated.

11. The convertible pin and base washer combination of claim 1, wherein the base washer and foldable flap is formed of galvanized steel.

12. The convertible pin and base washer combination of claim 1, wherein the base washer and foldable flap is formed from a rigid polymer plastic.

13. The convertible pin and base washer combination of claim 12, wherein the rigid polymer is polyvinyl chloride.

14. The convertible pin and base washer combination of claim 1, wherein the base washer has a cross-sectional area of at least about 200 times the cross-sectional area of the shank of said pin.

15. The convertible pin and base washer combination of claim 1, wherein the flap portion has a cross-sectional area of at least about 30 times the cross-sectional area of the shank of said pin.
